(19) United States
(12) Patent Application Publication
(10) Pub. No.: US 2005/0228934 A1
(43) Pub. Date: Oct. 13, 2005

(54) USB upstream device, USB connector, and USB cable

(75) Inventor: Tatsumi Tsutsui, Kasugai (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/147,166

(22) Filed: Jun. 8, 2005

Related U.S. Application Data
(63) Continuation of application No. PCT/JP03/05247, filed on Apr. 23, 2003.

(51) Int. Cl. G06F 13/00

(52) U.S. Cl. 710/313

(57) ABSTRACT

It is an object to provide a USB upstream device, a USB connector, and a USB cable, capable of operating stably by preventing malfunction due to a signal line defined as a high impedance state depending on a data transmission mode in the USB upstream device, when inserting or removing the USB upstream device into or from the USB. In a USP upstream device 1, a switch circuit 11 is provided between a signal line D− and grounding voltage. When the USB upstream device 1 is connected to the USB, power is supplied through VBUS line in the USB cable and the signal line D− is cut off from the grounding voltage. When cut off from the USB, the power supply through the VBUS line is cut off, and the switch circuit 11 conducts. Then, a discharge route is established. Unnecessary charge such as leak current or the like is discharged to the grounding voltage through the switch circuit 11. As a result, in a state separated from the USB, a voltage level of the signal line D− is maintained at a low voltage level.

### CROSS-REFERENCE TO RELATED APPLICATIONS

This application is a continuation application based upon and claims the benefit of the prior PCT International Patent Application No. PCT/JP2003/005247 filed on Apr. 23, 2003, the entire contents of which are incorporated herein by reference.

### BACKGROUND OF THE INVENTION

1. Field of the Invention

The present invention relates to a USB upstream device, a USB connector, and a USB cable, and more particularly to a USB upstream device, a USB connector, and a USB cable capable of operating stably even when inserting or removing the USB upstream device into and from the USB or in noisy environment.

2. Description of the Related Art

In a universal serial bus (USB) disclosed in non-patent document 1 described below, a USB peripheral device (USB upstream device) can be inserted or removed into or from the USB while power is being supplied. Depending on a terminal end state of signal lines D+, D− in the USB upstream device, data transfer speed with a host controller or a hub controller (USB downstream device) can be distinguished. That is, by pulling up either one of the signal line D+ or D−, data transfer speed to the USB upstream device can be distinguished.

Specifically, as shown in FIG. 7, when the signal line D+ is pulled up, the USB upstream device 100 is recognized as a full speed device. Or, as shown in FIG. 8, when the signal line D− is pulled up, the USB upstream device 150 is recognized as a low speed device.

Prior art document is shown below.

Non-Patent Document 1:
“Universal Serial Bus Specification,” [online], Apr. 27, 2000, Internet <http://www.org/developers/data/usb_{—}20.zip>

### SUMMARY OF THE INVENTION

In the USB, however, depending on the operating status, either one of the signal line D− or D+ defined in a high impedance state may be varied to an unexpected voltage level. As a result of this voltage variation, the USB downstream device 200 (FIG. 7) or USB upstream device 100 (FIG. 7), 150 (FIG. 8) may falsely recognize the communication status. Specifically the following three problems may occur.

A first problem is false recognition of data transfer speed (see FIG. 9). Generally, the USB upstream device is composed of a semiconductor device, and signal lines D+, D− are connected to terminals of the semiconductor device. PN junction exists in the semiconductor device, but it is known that leak current flows in the PN junction even if inversely biased. When this leak current flows into the USB cable connected to the USB upstream device through the terminal, it is charged in the parasitic capacity of signal line D− or D+ defined in the high impedance state. Usually, since USB cable is connected to USB upstream device, after a sufficient charging time, charge may be accumulated in parasitic capacity in the signal line D− or D+ defined in the high impedance state.

In this state, when the USB cable is connected to the USB downstream device, the charge accumulated in the signal line D− or D+ in the high impedance state is discharged by way of a pull-down resistance element RHpd provided in the host controller. This discharge current flows in the pull-down resistance element RHpd, and voltage pulse noise of high level is generated in the signal line D− or D+ in the high impedance state. Depending on the manner of connection of the USB connector, time difference occurs in the connection of signal lines D+, D−, noise of high level may be detected at the signal line D− or D+ in the high impedance state, prior to the intended operation of detection of high level as the signal line D+ or D− being pulled up is connected to the USB downstream device. As a result, it may be falsely recognized that the signal line D− or D+ in high impedance state is being pulled up, and data transfer capacity of the USB upstream device may be falsely recognized.

In FIG. 9, as the signal line D+ being pulled up is connected to the USB downstream device, the signal line D+ should be detected to be high level so as to be recognized as full speed device, but actually the signal line D− in the high impedance state is connected first, and the accumulated charge is discharged through the pull-down resistance element RHpd of USB downstream device, and the noise of high level of signal line D− is detected, and it is falsely recognized as a low speed device. When signal lines are exchanged, needless to say, the low speed device is falsely recognized as a full speed device.

A second problem is failure of a suspend function in separation of the USB upstream device during operation (see FIG. 10). When separating the USB upstream device from the USB, if separated in an idle state free from data transfer, the voltage level of the signal line D− or D+ in the high impedance state is gradually raised from a low level. The suspend function provided in the USB upstream device is to transfer the USB upstream device to a power saving mode with operation by detecting transition of a voltage level on the basis of this idle state.

Accordingly, if cut off during data transfer, the voltage level of the signal line D− or D+ in the high impedance state may be unstable. As a result, the USB upstream device may be cut off without recognizing the idle state, and the suspend function may fail to operate normally, which is a problem because the consumption current of the USB upstream device after cutting off cannot be decreased. In particular, when the USB upstream device is a portable appliance such as digital camera, the battery is consumed earlier, and it is a practical problem.

A third problem is occurrence of an unexpected signal state due to disturbance of waveform or entry of noise at the time of signal transition (see FIG. 11). In the general standard of USB, as for a J or K state, a potential difference of over 200 mV is demanded between the signal lines D+ and D−, with either signal D+ or D− as a high side. As for an SE0 or SE1 state, it is required that the signal lines D+ and D− are both less than or more than a specified voltage. In the J or K state, the differential voltage between the signal lines D+ and D− is specified as standard, and in the SE0 or SE1 state, the voltages of the signal lines D+ and D− are directly specified as standard. Accordingly, depending on a case, both the standard about differential voltage and the standard about the voltage level of signal lines may be satisfied at the same time, and a plurality signal states may be recognized depending on the voltage level in the signal lines D+ and D−. In particular, due to overshoot at the time of signal transition, or deviation of signal level by entry of noise, a plurality signal states may be established.

For example, FIG. 11 shows a transition state of the signal lines D+, D'1 at the end of packet (EOP) in full speed setting. In transfer from the K state to the SE0 state, the signal line D− of a high level is changed to a low level. Since the signal line D− is in the high impedance state, as a result of signal transition, voltage fluctuation due to overshoot or noise may occur in the signal line D−. By this voltage fluctuation, if the signal line D− swings to low voltage level of over 200 mV with respect to the signal line D+, although the signal lines D+ and D− are in the SE0 state, they may be also falsely recognized as the J state.

When falsely recognized as J state, it may be also recognized as unnecessary bit data, and malfunction may occur. Besides, since the duration of the SE0 state is detected to be shorter, the end of packet (EOP) may not be recognized correctly in the shortened period. As the end of packet (EOP) is not recognized correctly, packet error or other false decision may occur.

In particular, when the USB cable length is extended by distributing the USB cable up to the front panel of personal computer, the cable wiring impedance becomes large, and false operation or false decision may be obvious depending on a combination with other devices.

Such overshoot or noise varies significantly depending on the combination of devices or cable wiring distribution, and it is hard to predict the effects. It is a problem because the USB cannot be presented in a stable operating environment.

The invention is devised to solve at least one of the problems of the prior art, and it is hence an object thereof to provide a USB upstream device, a USB connector, and a USB cable, capable of operating stably even when inserting or removing into or from the USB or in a noisy environment, by preventing malfunction due to a signal line defined as a high impedance state depending on a data transmission mode in the USB upstream device, when inserting or removing the USB upstream device into or from the USB.

To achieve the above object, a USB upstream device according to one aspect of the invention, having a transmission mode for transmitting information in a state of a pull-up element connected to a first signal line, of signal lines in a USB cable, comprises a first switch for pulling down a second signal line by conducting when not connected to the USB.

In the USB upstream device according to one aspect, when the pull-up element is connected to the first signal line and information is transferred, if not connected to the USB, the first switch conducts, and the second signal line is pulled down.

Herein, the USB downstream device is a host controller or hub controller in the USB, and the USB upstream device is a peripheral device connected to the USB.

In the USB upstream device separated from the USB, accordingly, the parasitic capacitance of the second signal line is prevented from being charged by the leak current or the like, and the potential of the second signal line is prevented from elevating. In the transmission mode in which the first signal line is pulled up, the second signal line defined as a high impedance state is not charged to an unexpected voltage level, and when the USB upstream device connects to the USB, abnormal current is not flow into the pull-down resistance of the USB downstream device, so the transfer capacity of the USB upstream device is not falsely judged.

Further, if separated from the USB during data transfer, since the second signal line is pulled down immediately after being separated, the USB upstream device can recognize the first and second signal lines as idle state. The suspend function operates normally, and the USB upstream device normally comes into suspend state, and is transferred to low power consumption state. It is particularly effective when applied in a case possibly separated from the USB in the midst of data transfer.

A USB upstream device according to another aspect of the invention, having a first transmission mode for transmitting information in a state of pull-up element connected to a first signal line, of signal lines in a USB cable, comprises a second pull-down element for pulling down a second signal line.

In the USB upstream device according to another aspect, when the pull-up element is connected to the first signal line and information is transferred, the second pull-down element is provided in the second signal line and is pulled down.

As a result, same as in the case of the one aspect, the parasitic capacitance of the second signal line is prevented from being charged by leak current or the like, and the potential of the second signal line is prevented from elevating, and when connected to the USB, the transfer capacity of the USB upstream device is not falsely judged. If separated from the USB in the midst of data transfer, since the second signal line is pulled down immediately after being separated, the first and second signal lines are recognized as idle state, and the USB upstream device is normally transferred to the suspend state.

In addition, also during a first transmission mode period, since the second signal line is connected to the pull-down voltage level, regardless of signal level transition or changes in ambient environments, generation of overshoot or noise in the second signal line can be suppressed. Variation of signal level of second signal line can be suppressed, and false decision of signal state can be prevented.

Regardless of environment of use changing variously depending on the combination of devices or distribution of USB cable, generation of overshoot and noise of second signal line can be suppressed, and the USB upstream device connected by the USB cable can be operated stably.

Herein, since the second signal line which is in the high impedance state by nature is pulled down, the pull-down state of the second signal line by the second pull-down element must be set in a range not having effects on the signal line driving capacity of the USB downstream device for transferring information to the USB upstream device by way of the USB cable. For example, when the second pull-down element is a resistance element, the high side driving capacity by the USB downstream device should maintain the second signal line at high level by overcoming the pull-down by the resistance element.

The USB connector according to one aspect or the USB cable according to one aspect comprises a third pull-down element connected to the first signal line, and a fourth pull-down element connected to the second signal line.

Accordingly, without changing the USB upstream device, in a simple configuration connecting third and fourth pull-down elements to the first and second signal lines of the USB connector or USB cable, stable information transfer is realized even when inserting or removing into or from the USB or in noisy environment.

The above and further objects and novel features of the invention will more fully appear from the following detailed description when the same is read in connection with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 a circuit diagram of main part in a first embodiment;

FIG. 2 is a view showing a length of a junction pin of a USB connector;

FIG. 3 is circuit diagram of main part in a second embodiment;

FIG. 4 is circuit diagram of main part in a third embodiment;

FIG. 5 is circuit diagram of main part in a fourth embodiment;

FIG. 6 is circuit diagram of main part in a fifth embodiment;

FIG. 7 is a view shoring a USB in a full speed transmission mode in a related art;

FIG. 8 is a view of the USB in a low speed transmission mode in the related art;

FIG. 9 is a waveform chart showing a first problem in the related art;

FIG. 10 is a waveform chart showing a second problem in the related art; and

FIG. 11 is a waveform chart showing a third problem in the related art.

### DETAILED DESCRIPTION OF THE PREFERRED EMBODIMENTS

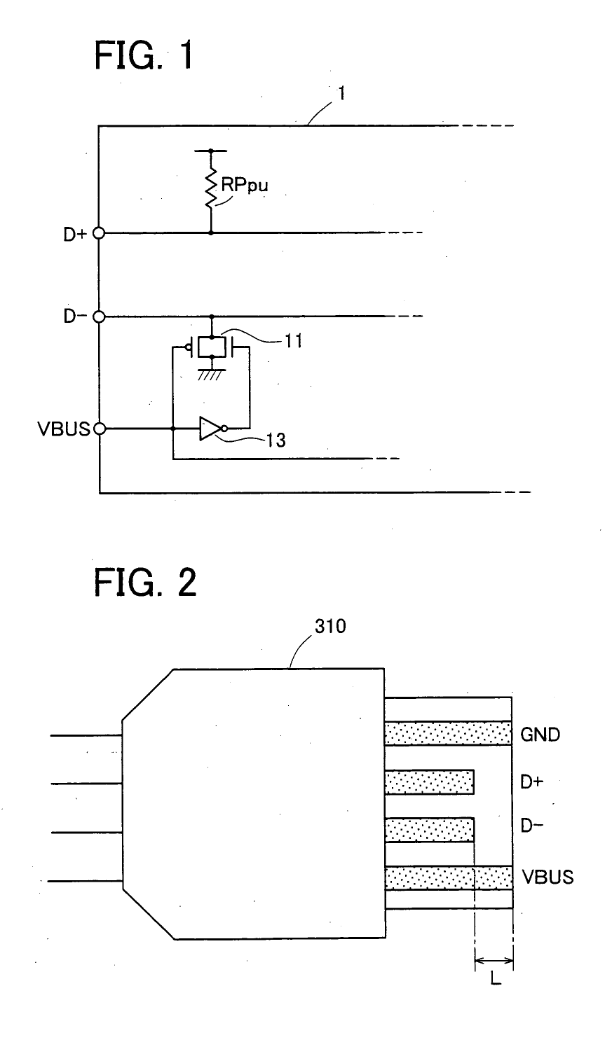

First to fifth embodiments of a USB upstream device, a USB connector, and a USB cable of the invention are specifically described below while referring to FIG. 1 to FIG. 6. In the following explanation, mainly a full speed transmission mode is explained as a USB transmission mode.

FIG. 1 is a circuit diagram of a USB upstream device in a first embodiment of the invention. The USB upstream device 1 has a pull-up resistance RPpu connected between a signal line D+ and supply voltage, and a switch circuit 11 between a signal line D− and grounding voltage. The switch circuit 11 may be, for example, a so-called transfer gate, composed by mutually connecting a source terminal and a drain terminal of a PMOS transistor and a NMOS transistor. A VBUS line is connected to a gate terminal of a PMOS transistor, and an inverted signal inverted from the VBUS line through an inverter gate 13 is connected to a gate terminal of the NMOS transistor.

When the USB upstream device 1 is connected to the USB, power is supplied through VBUS line in the USB cable. This is the power to be supplied to a self-supporting device not having power supply wire such as mouse. In the USB upstream device 1, supply voltage supplied to the VBUS line is supplied to the gate terminal of the PMOS transistor as a high level signal, and is also supplied to the gate terminal of the NMOS transistor as a low level signal inverted by the inverter gate 13. Both PMOS and NMOS transistors are non-conductive, and the switch circuit 11 is non-conductive, and the signal line D− is cut off from the grounding voltage to be in the high impedance state. On the other hand, a signal line D+ is in a pull-up state by a pull-up resistance RPpu.

In the USB upstream device 1, the signal line D+ is maintained in the pull-up state and is connected to the USB, and the signal line D− is in the high impedance state, and information is transferred in a full speed transmission mode.

When cut off from the USB, the power supply through the VBUS line is cut off. The VBUS line comes to a low voltage level in the USB upstream device 1, and it is supplied to the gate terminal of the PMOS transistor as a low level signal, and supplied to the gate terminal of the NMOS transistor as a high level signal inverted by the inverter gate 13. Both PMOS and NMOS transistors conduct, and the switch circuit 11 conducts, and the signal line D− is connected to the grounding voltage, and a discharge route is established. Leak current leaking out to the signal line D− in the USB upstream device 1, and unnecessary charge accumulated in the wiring capacity of the signal line D− are discharged to the grounding voltage by way of the switch circuit 11. As a result, in a state separated from the USB, the voltage level of the signal line D− is maintained at the low voltage level.

Herein, with the USB cable being connected to the USB upstream device 1, when the USB connector is cut off at the USB downstream device side as the opposite side device, a long wiring including from the USB connector to the USB cable is connected as the signal line D− of the USB upstream device 1, and an enormous wiring capacity is connected to the signal line D−. In the first embodiment, since the signal line D− is connected to the grounding voltage by way of the switch circuit 11, and regardless of the level of the wiring capacity, the signal line D− can be maintained effectively at the low voltage level.

As explained herein, according to the USB upstream device 1 of the first embodiment, the USB downstream device and USB upstream device 1 are connected by USB cable, and when power is supplied to the USB upstream device 1 by way of VBUS line, the signal line D− becomes in the high impedance state. Since the signal line D+ is pulled up, the USB upstream device 1 can be set in the full speed transmission mode.

When the USB connector is cut off at least at either USB upstream device 1 side or USB downstream device side, power supply from the VBUS line is interrupted, and the switch circuit 11 conducts, and the signal line D− and grounding voltage are connected. Leak current to the signal line D− can be effectively discharged, and the voltage level of the signal line D− can be maintained at the low voltage level.

In the USB upstream device 1 being cut off from the USB, the parasitic capacitance of the signal line D− as an example of a second signal line is prevented from elevating due to charge by leak current. In the full speed transmission mode where the signal line D+ as an example of a first signal line is pulled up, even if the signal line D− defined to be in the high impedance state is charged to an unexpected voltage level, and connected to the USB, no abnormal current flows in the pull-down resistance of the USB downstream device, and the transfer capacity of the USB upstream device 1 may not be falsely judged.

Further, when being cut off from the USB during data transfer, since the signal line D− is pulled down immediately after being cut off, the USB upstream device 1 can recognize the signal lines D+, D− as idle state. The suspend function operates normally, and the USB upstream device 1 is normally suspended, and transfers to low power consumption state. If the USB upstream device 1 is a digital camera or other portable appliance, it may be cut off from the USB during transfer of data through the USB considering from its portable use. When the first embodiment is applied to such device, it can be transferred to the suspend state securely after being cut off, and a low power consumption state of the device can be maintained. In the case of a portable appliance, by suppressing power consumption, the duration of continuous use can be extended.

FIG. 2 is a plan view of USB connector 310. The length of a junction pin of a USB connector 310 is determined so that the signal lines D+, D− disposed inside is shorter by a length L as compared with the VBUS line and a grounding line GND disposed at both ends. Therefore, when connecting the USB connector 310 to the device, first the VBUS line and the grounding line GND are connected to the device side, and then the signal lines D+, D− are connected. Since the USB connector 310 is connected manually, the time difference tL of connection of the VBUS line and the grounding line GND and connection of the signal lines D+, D− depends on the manual connection, and it is known to be about tens of ms to hundreds of ms.

In the first embodiment, when connecting the USB connector, while power is supplied by the VBUS line at time difference tL, the signal lines D+, D− are not connected. That is, the non-conducting state of the switch circuit 11 continues for the time difference tL. At the current amount of ordinary leak current, in a short time difference of tL of tens of ms to hundreds of ms, the wiring capacitance of signal line in the high impedance state will not be charged.

However, if the leak current amount is large or depending on the wiring capacity, the voltage level of signal line may be raised within the time difference tL. To prevent this, a discharge route of the signal line should be formed within the time difference tL. This configuration is shown in the second embodiment to fifth embodiment.

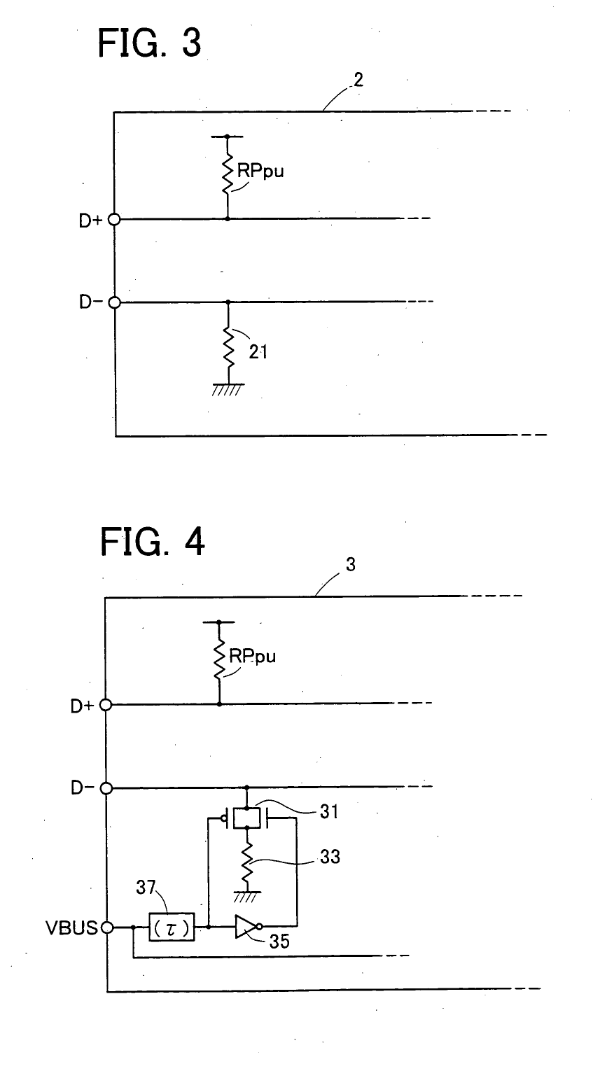

In the USB upstream device 2 in the second embodiment shown in FIG. 3, a resistance element 21 is provided instead of the switch circuit 11 in the USB upstream device 1 (FIG. 1) in the first embodiment. By connecting between the signal line D− and grounding voltage by the resistance element 21 which is a passive element, a discharge route of charge from the signal line D− is always formed.

As a result, regardless of a connection state of the USB connector, since the discharge route from the signal line D− to the grounding voltage is formed, the voltage level of the signal line D− is not raised due to accumulation of unnecessary charge such as leak current in the wiring capacitance of the signal line D−. If the connection timing with the device varies in each junction pin when inserting or removing the USB connector due to a difference in a junction pin length of the USB connector, unnecessary charge is not accumulated in the signal line D− defined to be in the high impedance state, and resulting malfunction can be prevented.

Since the resistance element 21 is connected to the signal line D− which is originally defined to be in the high impedance state, strictly, the signal line D− is not in the high impedance state. However, by setting a resistance value of the resistance element 21 within a range of driving capacity of the driver for driving the signal line D−, there is no problem in information transfer. Current consumption by the resistance element 21 can be adjusted by selecting the resistance value of the resistance element 21. That is, by setting at a balanced resistance value of capacity of discharge of unnecessary charge when not connected to the USB, ordinary transfer capacity necessary when connected to the USB, and current consumption through the resistance element 21, a full speed transmission mode of setting the signal line D− in the high impedance state can be executed without any problem. A specific resistance value may be, for example, 1 M-ohm. Further, depending on the wiring capacitance of the signal line D−, the resistance value can be changed properly within a range of drive capacity. In the case of a large wiring capacitance, a resistance element 21 having a smaller resistance value may be provided in a driving range of the signal line D−. An applicable resistance value is, for example, in a range of 1.5 k-ohm to 1 M-ohm.

As explained herein, according to the USB upstream device 2 of the second embodiment, by always connecting the signal line D− defined as the high impedance state to the grounding voltage by the resistance element 21, discharge route from the signal line D− to the grounding voltage is assured, and in a state being cut off from the USB, the same action and effect as in the first embodiment are expected. In addition, the leak current can be discharged effectively to the signal line D− including from the separated state to the completed state of connection, and the voltage level of the signal line D− can be maintained at low voltage level.

Besides, since the signal line D− is always connected to the grounding voltage by way of the resistance element 21, if being cut off from the USB during data transfer, after being cut off, the signal line D− is immediately pulled down, and the signal lines D+ and D− are recognized as idle state, and the USB upstream device 2 is normally transferred to the suspend state.

In addition, during the full speed transmission mode, since the signal line D− and grounding voltage are connected, regardless of transition of signal level or changes of ambient environments, generation of overshoot or noise in the signal line D− can be suppressed. Fluctuations of signal level of the signal line D− can be suppressed, and wrong judgement of the signal state can be prevented.

Regardless of environment of use changing variously depending on the combination of devices, or distribution of the USB cable, overshoot or noise of the signal line D− can be suppressed, and the USB upstream device 2 connected by the USB cable can be operated stably.

FIG. 4 shows a configuration of the USB upstream device 3 in a third embodiment, in which the current route by the resistance element 21 is cut off in the full speed transmission mode and the signal line D− is set in the high impedance state conforming to the standard. Instead of the resistance element 21 of the USB upstream device 2 (FIG. 3) in the second embodiment, a switch circuit 31 is provided for opening and closing the resistance element 33 and discharge route.

The switch circuit 31 has a same configuration as the switch circuit 11 (FIG. 1) in the first embodiment. In the USB upstream device 3, further, there are a delay circuit 37 and an inverter gate 35 to which an output terminal of the delay circuit 37 is connected. VBUS line is connected to an input terminal of the delay circuit 37. The output terminal of the delay circuit 37 and the output terminal of the inverter gate 35 are connected to gate terminals of the PMOS and NMOS transistors for composing the switch circuit 31.

By connection to the USB, power is supplied to the VBUS line, and when the voltage level of the VBUS lines reaches a high level, after a waiting time τ, high/low level voltage is applied to the gate terminals of the PMOS/NMOS transistors of the switch circuit 31, and the switch circuit 31 is non-conductive. The switch circuit 31 which has been conducting while being cut off from the USB becomes non-conductive after delay time τ from connection of the VBUS line. By setting the delay time τ longer than the time difference tL explained in FIG. 2, after the signal line D− is connected later than connection of the VBUS line at the time of connection to the USB, the discharge route of the signal line D− is cut off.

As described herein, according to the USB upstream device 3 of the third embodiment, the timing of the signal line D− defined as the high impedance state being cut off from the grounding voltage is set after the delay time τ from connection of the VBUS by connection operation to the USB, in the state of the USB upstream device 3 being cut off from the USB, and in a state from separated state until completion of connection, the same action and effect as in the second embodiment are obtained. In addition, in the data transfer state after connection to the USB, since the signal line D− is cut off from the grounding voltage, no current flows from the signal line D− to the grounding voltage. While the signal line D− in the original high impedance state, the data is transferred at full speed.

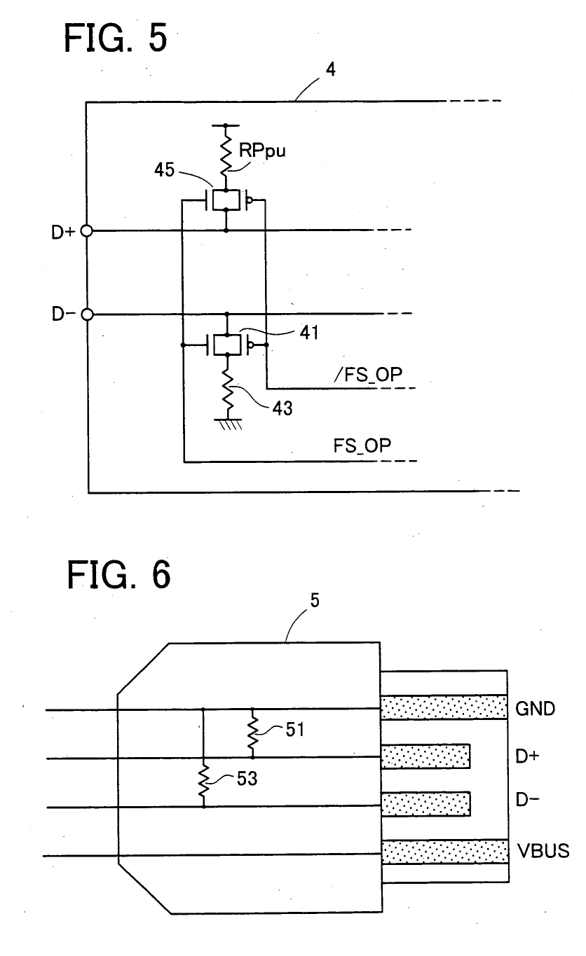

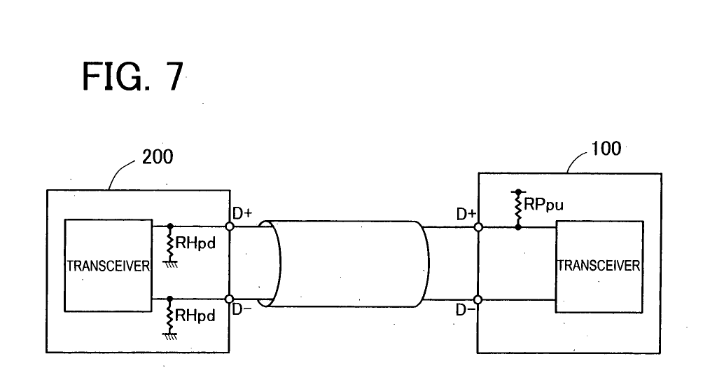

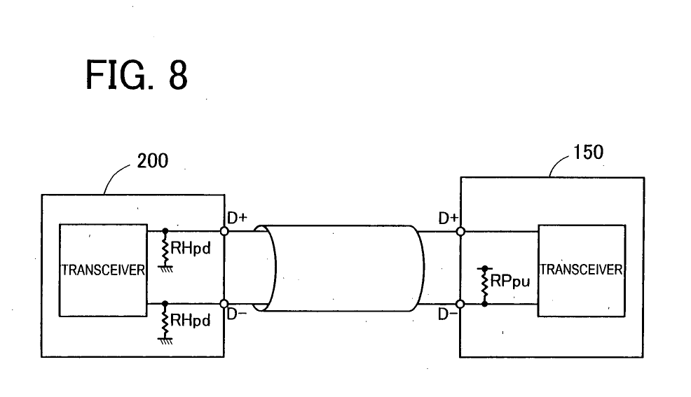

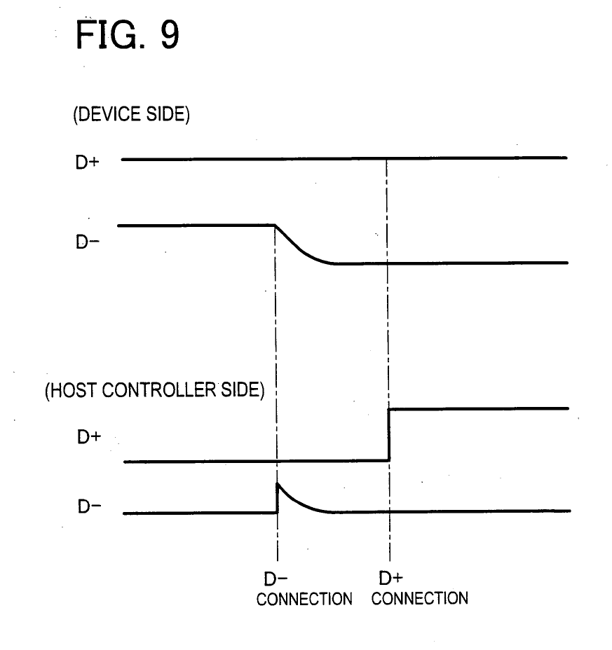

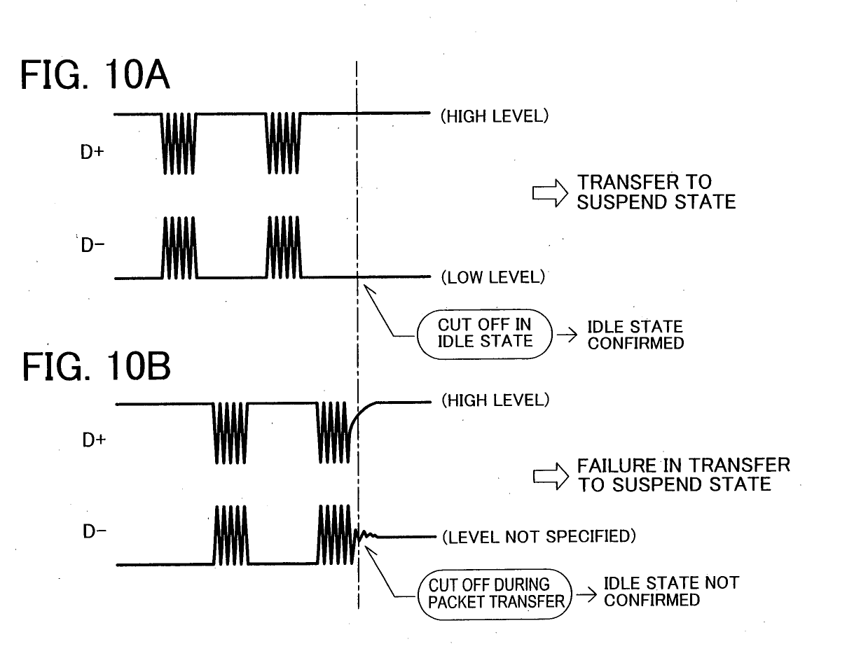

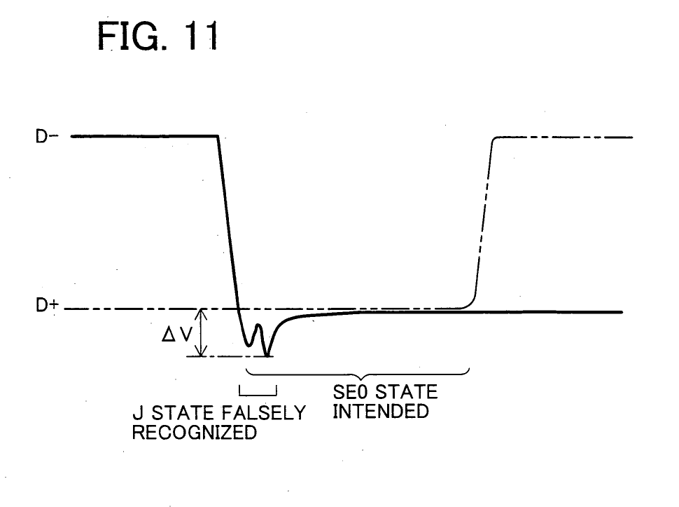

The USB upstream device 4 in the fourth embodiment shown in FIG. 5 is an embodiment applied to the device conforming to USB 2.0 standard. In the USB 2.0, one device supports two transmission modes, a high speed mode and a full speed mode. In the full speed mode, the signal line D+ is pulled up, and in the high speed mode, the signal lines D+ and D− both operate in the high impedance state.

In the USB upstream device 4, a pull-up resistance element RPpu is provided between the signal line D+ and supply voltage through switch circuit 45, and resistance element 43 is provided between the signal line D− and grounding voltage through switch circuit 41.

Switch circuits 41, 45 are same in configuration as the switch circuit 11 (FIG. 1) in the first embodiment. In the USB upstream device 4, a control signal FS_OP instructing a transmission mode controls the gate terminal of NMOS transistors for composing the switch circuits 41, 45, and its inverted signal, /FS_OP signal controls the gate terminal of PMOS transistors composing the switch circuits 41, 45. Herein, the control signal FS_OP is a signal becoming a low level at the time of the high speed transmission mode. Therefore, it is a high level in the full speed transmission mode, and also a high level when separated from the USB.

When separated from the USB, the control signal FS_OP is at high level, and the switch circuits 41, 45 conduct. Therefore, the signal line D+ is pulled up to supply voltage level, and the signal line D− is pulled down to grounding voltage level. Since the signal lines D+ and D− are maintained at a specified voltage level, a discharge route of leak current is established, and the voltage level does not fluctuate due to accumulation of charge in the wiring capacity.

In particular, when the USB upstream device 4 is set in the full speed transmission mode, the signal line D− is defined in the high impedance state, and data is transferred, but when not connected to the USB prior to start of transfer, the signal line D'1 is connected to the grounding voltage, and the voltage level is not raised by leak current.

When connected to the USB in the full speed transmission mode, since the control signal FS_OP maintains a high level before and after connection, the signal line D− maintains the state being connected to the grounding voltage. Even if the connection timing to the device varies in each junction pin due to difference in length of junction pin in the USB cable, unnecessary charge is not accumulated in the signal line D− defined as the high impedance state, and the resulting malfunction can be prevented.

In the fourth embodiment, even during transfer in the full speed transmission mode, the signal line D− originally defined as the high impedance state is connected to the grounding voltage by way of resistance element 43. Also in this state, however, same as in the case of the second embodiment (FIG. 3), by adjusting the resistance value of the resistance element 43, discharge capacity of unnecessary charge while not connected to the USB, ordinary transfer capacity in connection to the USB, and current consumption through the resistance element 43 are balanced, and the full speed transmission mode of setting signal line D− in the high impedance state can be executed without any problem.

Further, when the USB upstream device 4 is set in the high speed transmission mode, the control signal FS_OP becomes low level, and the switch circuits 41, 45 are both in the non-conductive state. Signal lines D+ and D− are both in the high impedance state, and the signal lines D+ and D− can be set in a bias state in the high speed transmission mode.

In this case, the switch circuits 41, 45 are preferred to be formed in same size and same configuration. As a result, the load is balanced in the signal lines D+, D− in the high impedance state, and the load symmetry between the signal lines in the high speed transmission mode of transfer by differential signal between the signal lines D+, D− can be maintained favorably, and the reliability of signal transfer in high speed transfer can be enhanced.

As explained herein, according to the USB upstream device 4 of the fourth embodiment, corresponding to the USB 2.0 standard, when transferring in the full speed transmission mode, flow of leak current into the signal line D− can be effectively discharged, and the voltage level of the signal line D− can be maintained at a low voltage level. Besides, since the signal line D− is connected to the grounding voltage by way of resistance element 43 even during transfer in the full speed transmission mode, voltage fluctuations due to overshoot or noise of the signal line D− can be prevented.

In the full speed transmission mode, since the signal line D− is always connected to the grounding voltage, if being cut off from the USB during data transfer, the signal line D− is pulled down immediately after being cut off, and the signal lines D+, D− are recognized as an idle state, and the USB upstream device 4 can be normally transferred to a suspend state.

In addition, the same actions and effects as explained in the first to third embodiments can be obtained.

In addition, in the high speed transmission mode, the switch circuits 41, 45 are both in the non-conductive state, and the signal lines D+, D− can be set in the high impedance state. At this time, when the circuit configuration of switch circuits 41, 45 and size of constituent elements are identical, the loads to the signal lines D+, D− are the same, and the reliability of signal transfer in the high speed transmission mode can be enhanced.

FIG. 6 shows a fifth embodiment of the invention applied to the USB connector. In the USB connector 5, resistance elements 51, 53 are provided between the signal lines D+, D− and grounding voltage. As explained in the resistance element 21 (FIG. 3) in the second embodiment, it is preferred to set the resistance value so as to balance the discharge capacity of unnecessary charge when the USB connector 5 is not connected, usual transfer capacity by driver when the USB connector 5 is connected, and current consumption through the resistance elements 51, 53. Further, considering connection of the device in the high speed transmission mode, it is desired to set the resistance value in consideration of load balance of the signal lines D+, D− and driving capacity in differential operation. As the resistance value of the resistance elements 51, 53, when set at 1 Mohm, for example, it is effective to operate for device connection in all transmission modes.

As explained herein, according to the USB connector 5 of the fifth embodiment, regardless of difference in the transmission mode such as low speed, full speed and high speed, by connecting to all devices, flow of leak current into the signal line D+ or D− defined as the high impedance state can be effectively discharged, and the voltage level can be maintained at a low voltage level. Even during data transfer, being connected to the grounding voltage by way of the resistance element 51 or 53, voltage fluctuations due to overshoot or noise of the signal line D+ or D− can be prevented. Besides, the same actions and effects as explained in the first to fourth embodiments can be obtained.

In addition, by a simple configuration of having the resistance elements 51, 53 in the USB connector 5, without changing the USB upstream device, information can be transmitted stably even when inserting or removing into or from the USB or in noisy environment.

Same effects are obtained even if the resistance elements 51, 53 are disposed in the USB cable.

The invention is not limited to these embodiments alone, but may be changed and modified within the scope of the invention.

For example, in the foregoing embodiments, mainly the full speed transmission mode is explained, but the invention is not limited to this alone, and may be similarly applied in the signal line D+ in the low speed transmission mode.

Voltage level in a pull-up/pull-down mode is not limited to the supply voltage/grounding voltage, but may be any high voltage level/low voltage level having a specified voltage.

Thus, the invention presents USB upstream device, USB connector, and USB cable capable of operating stably even when inserting or removing the USB upstream device into and from the USB or in noisy environment, by preventing malfunction due to signal line defined as the high impedance state depending on the data transmission mode when inserting or removing the USB upstream device into and from the USB.

1. A USB upstream device having a transmission mode for transmitting information in a state of a pull-up element connected to a first signal line, of signal lines in a USB cable, comprising:
a first switch for pulling down a second signal line by conducting when not connected to the USB.

2. The USB upstream device of claim 1, wherein a first pull-down element is provided in a first pull-down route established by conduction of the first switch.

3. The USB upstream device of claim 1, wherein the first switch is controlled depending on a VBUS signal supplied through the USB cable.

4. The USB upstream device of claim 1, wherein the transmission mode is a low speed transmission mode or a full speed transmission mode.

5. A USB upstream device having a first transmission mode for transmitting information in a state of pull-up element connected to a first signal line, of signal lines in a USB cable, comprising:
a second pull-down element for pulling down a second signal line.

6. The USB upstream device of claim 5, further comprising a second switch provided in a second pull-down route by way of the second pull-down element,
wherein the second switch conducts while not connected to the USB, and in a period including from the non-connected state to the state of connection of the second signal line.

7. The USB upstream device of claim 6, further comprising a third switch provided in a pull-up route by way of the pull-up element,
wherein the second switch is non-conductive in a second transmission mode of transmission of information while the third switch is not conductive.

8. The USB upstream device of claim 7, wherein the second and third switches are respectively connected to the first and second signal lines, and compose mutually equivalent loads to the first and second signal lines.

9. The USB up stream device of claim 5, wherein the first transmission mode is a low speed transmission mode or full speed transmission mode.

10. The USB upstream device of claim 7, wherein the first transmission mode is a low speed transmission mode or full speed transmission mode, and the second transmission mode is a high speed transmission mode.

11. A USB connector comprising a third pull-down element connected to a first signal line, and a fourth pull-down element connected to a second signal line.

12. The USB connector of claim 11, wherein the third and fourth pull-down elements compose mutually equivalent loads to the first and second signal lines.

13. A USB cable comprising a third pull-down element connected to a first signal line, and a fourth pull-down element connected to a second signal line.

14. The USB cable of claim 13, wherein the third and fourth pull-down elements compose mutually equivalent loads to the first and second signal lines.
